(19) United States
(12) Patent Application Publication
(10) Pub. No.: US 2006/0032805 A1
(43) Pub. Date: Feb. 16, 2006

(54) Heating plate for vacuum filter press

(76) Inventors: Mark W. Hildebrant, Holland, MI (US); Terry A. Morley, West Olive, MI (US); Matthew J. Bosch, Allendale, MI (US); Kenneth A. Marchek, Holland, MI (US)

Correspondence Address: FLYNN THIEL BOUTELL & TANIS, P.C., 2026 RAMBLING ROAD, KALAMAZOO, MI, 49008-1631, US

(21) Appl. No.: 10/527,617

(22) PCT Filed: Sep. 12, 2003
(86) PCT No.: PCT/US03/29161

§ 371 Date: Mar. 11, 2005

Related U.S. Application Data
(60) Provisional application No. 60/410,552, filed on Sep. 13, 2002.

(51) Int. Cl. B01D 25/164

(52) U.S. Cl. 210/228; 210/230; 210/231

(57) ABSTRACT

A filter press (11) defined by a closable stack of filter plates defined by a first plurality of membrane filter plates (21) alternately disposed with a second plurality of heating-type filter plates (22). The membrane plates (21) have chamber-defining recesses on opposite sides thereof, with each recess (36) having a flexible membrane (39) associated therewith which can be pressurized from the rearward side so as to effect squeezing of the cake in the filtration chamber. Each heating plate (22) also has chamber-defining recesses (74) on opposite sides thereof, and the main center bottom wall (76) of each recess (74) has a metal heat transfer surface (77) associated therewith, the rear side of which is in intimate contact with a chamber or passage (79) which receives therein a high-temperature heat transfer fluid.

### FIELD OF THE INVENTION

This invention relates to a filter press for dewatering slurry and, more specifically, to an improved filter press for permitting heating and drying of filter cake formed in filtration chambers of a filter press to permit more efficient separation of liquid from slurry, and the method for effecting such separation.

### BACKGROUND OF THE INVENTION

Filter presses are well known and extensively utilized for separating solids from slurries. Such filter presses employ a plurality of filter plates which are held in contacting relationship between fixed and movable head members while the slurry is pumped into and through the press for collecting the solids in the form of cake between adjacent filter plates. When the press is full, the movable head is backed away from the plates into an open position and the plates are moved into an open position to permit discharge of the cake which is collected between adjacent pairs of plates. To permit movement of the plates into an open position, plate shifting mechanisms are typically provided adjacent opposite sides of the press for permitting automatic or manual control over the plate movement and cake discharge.

Various types of filter plates are utilized in filter presses, depending primarily upon the material to be filtered and the process requirements. For example, one type of plate is a cloth-type chamber plate which includes recessed surfaces on opposite sides of the plate, each of which serves to form a filter chamber with an adjacent plate when the plates are clamped together. A cloth filter covers each of these recessed surfaces, and is either mounted on the plate by a gasket or is draped between two adjacent plates. Thus, slurry is pumped into the filter chambers formed between the filter cloths of two adjacent plates, and the liquid from the slurry passes through the filter cloth and is discharged through filtrate ports in the plates. The solids are trapped in the filter chamber and form a cake.

Another type of filter plate which is utilized when process requirements call for production of a dryer filter cake is a membrane or diaphragm-type squeeze plate. The construction of this type of plate is similar to the cloth-type chamber plate, but the drainage surfaces on the opposite faces of the plate are flexible diaphragms or membranes which define pressurizing chambers therebehind. A filter cloth covers the outer face of the diaphragm on each side of the plate and typically extends beyond the plate, i.e., the filter cloths are typically draped between the adjacent plates. In this case, slurry is pumped into the filter chambers formed between two neighboring plates and the liquid portion of the slurry passes through the filter cloths and is discharged through filtrate ports in the plates. After the filling cycle is complete and the filter chambers formed between adjacent plates are filled with solids, and before the press is opened, pressurized air or water is supplied to the chamber located behind each diaphragm, causing the diaphragms to flex outward and exert mechanical pressure on the filter cake. This also effects limited heating of the filter cake which, in conjunction with a vacuum applied to the discharge side of the filter cloths, causes additional moisture to be removed from the filter cake. An example of this type of arrangement and process is disclosed in U.S. Pat. No. 5,558,773. A similar press and process is also sold by the assignee hereof under the designation “J-VAP”.

While filter presses employing membrane-type filter plates have provided improvement with respect to removal of liquid from the filter cake, nevertheless such membrane-type filter plates are of limited capability with respect to their ability to provide effective heating of the filter cake to assist in moisture removal by vaporization. It accordingly has been proposed to modify the filter press to include heating plates in conjunction with membrane-type filter plates. In such proposal, as illustrated by U.S. Pat. No. 6,387,282, a plurality of rigid metal heating plates are alternately interposed between the plurality of conventional membrane-type filter plates. Each heating plate is hence clamped between a pair of membrane-type plates when the filter press is closed, whereby each filter chamber is defined between the opposed faces of the adjacent membrane-type filter plate and the adjacent heating plate, and the size of the filtration chamber and hence the capacity thereof is defined principally by the recess formed in the membrane-type filter plate inasmuch as the opposed surface on the heating plate is typically flat. Since the heating plate is constructed of metal and has interior chambers and passages for accommodating a high-temperature heating fluid therein, such heating plate is effective in permitting transfer of significant quantities of heat energy through the metal face of the heating plate into the adjacent filter cake. Such arrangement hence does permit increased heating and accordingly more effective vaporization of the liquid in the filter cake, whereby more effective removal of liquid from the filter cake can be achieved.

With a filter press employing alternating metal heating plates of the type described above, however, the overall construction of the filter press, in order to maintain the same press capacity, increases significantly with respect to the structure and size thereof since the same number of membrane-type filter plates must be maintained, and at the same time a substantially similar number of heating plates are incorporated into the press, thereby significantly increasing the overall size (i.e., length) and also the space requirements and cost of the press.

In addition, in a press having alternating membrane-type and metal heating plates as mentioned above, the heating plates are constructed substantially entirely of metal and function solely to provide heat to the filter cake, but are not designed to cooperate with or promote other required or desired operational features of the press. For example, the metal heating plates are not provided with ports or openings which communicate with the adjacent filtration chamber, whereby all drainage of liquid from the filtration chamber must occur through ports located solely adjacent one side thereof, namely through ports provided in the membrane-type filter plate. This restricts the ability of the press to effect efficient drainage of liquid from the filtration chamber. This also restricts the effective use of air blow into and through the filter cake to further assist in vapor removal since the only ports available for air blow are provided on one side of the filtration chamber, namely in the membrane filter plate, and as such the air blow can effect movement of air only transversely across the filter cake and not longitudinally through the thickness thereof, whereby the effectiveness of the air blow is believed significantly impaired.

Other examples of plate-type filter presses employing heating plates to provide more effective heating of filter cake within the press are illustrated by U.S. Pat. No. 4,999,118, U.S. Pat. No. 1,049,715, and PCT Publication WO 95/27550.

It is an object of the present invention to provide an improved filter press which overcomes or minimizes the disadvantages associated with prior press constructions, as briefly discussed above.

More specifically, it is an object of this invention to provide an improved filter press employing both membrane filter plates and heating filter plates disposed in alternating fashion along the press, with said plates being constructed so as to maintain press capacity without requiring any significant increase in either the number of required plates or the overall size of the press, while permitting heat to be effectively transmitted into the filter cakes formed in the filtration chambers to effect vaporization thereof, and at the same time permitting more effective removal of liquid or vapor from the filter cake, such as during air blowing and vacuum-drawing cycles.

It is a further object of the invention to provide an improved filter press, as aforesaid, which enables the heating plates to be provided with metal heat transfer surfaces which define one side of each filtration chamber, with the overall construction of the remainder of the heat plate still employing a frame constructed principally of a non-metal material to permit forming of the heating plates in a more economical and more consistent manner similar to the construction of the membrane-type filter plates.

In the improved filter press of the present invention, the press is defined by a closable stack of filter plates defined by a first plurality of membrane filter plates which are alternately disposed with a second plurality of heating-type filter plates. The membrane plates, as is conventional, have chamber-defining recesses on opposite sides thereof, with each recess having a flexible membrane associated therewith which can be pressurized from the rearward side so as to effect squeezing of the cake in the filtration chamber. Each heating plate also has chamber-defining recesses on opposite sides thereof, and the main center bottom wall of each recess has a metal heat transfer surface associated therewith, the rear side of which is in intimate contact with a chamber or passage which receives therein a high-temperature heat transfer fluid.

When the press is closed, a filtration chamber is defined by opposed recesses defined between each adjacent contacting pair of membrane and heating plates, whereby a membrane can effect squeezing of the filter cake in the chamber from one side thereof, and the heating surface on the opposed plate can effect efficient heating of the filter cake from the opposite side thereof. Each of the membrane and heating plates has porting associated therewith which communicates with preferably upper and lower extremities of the filtration chamber, with the upper and lower ports in the membrane plate preferably being substantially diametrically opposite the respective lower and upper ports formed in the opposed heating plate. The diametrically opposed upper and lower ports formed in the membrane and heating plates permit air to be effectively blown into and through the filter cake, with the air passing both transversely across the width of the filter cake and longitudinally through the thickness thereof, to significantly assist in removing liquid or vapor from the filter cake. In addition, the lower ports formed in the opposed membrane and heating plates permit communication to be established with the lower extremity of the filtration chamber adjacent both sides of the filter cake so as to permit more effective drainage of liquid therefrom.

In the improved filter press of the present invention, as aforesaid, the heating plates in one embodiment are defined by frames constructed of a plastics material so as to have a construction similar to the plastic frames defining the membrane filter plates, and the heat transfer surfaces are preferably defined by thin metal plates, such as of stainless steel, which are fixed to opposite sides of the plastic frame and extend over substantially the entire bottom of the recesses formed in opposite sides thereof so as to provide a high-efficiency heat transfer surface which contacts the filter cake over substantially the entirety of one side of the filtration chamber. With this arrangement, the high-temperature heating fluid supplied to and through the interior of the heating plate permits more effective and high-efficiency transfer of heat to the metal heating plate, particularly since the plastic frame of the heating plate has a much smaller heat transfer capability and exerts minimal impact as a heat sink relative to its effect on removal of heat energy from the heating fluid.

It will be appreciated that the heating-type filter plates according to the invention may also be used in conjunction with conventional cloth-type chamber plates discussed above as opposed to membrane-type squeeze plates.

Other objects and purposes of the present invention will be apparent to persons familiar with constructions of this general type upon reading the following specification and inspecting the accompanying drawings.

### BRIEF DESCRIPTION OF THE DRAWINGS

FIGS. 1 and 2 are diagrammatic top and side views, respectively of a generally conventional filter press incorporating therein alternating membrane and heating filter plates according to the present invention.

FIG. 3 is an exploded view of a portion of the filter press of FIGS. 1 and 2, and showing adjacent membrane and heating filter plates.

FIG. 4 is a central longitudinally-extending cross section through four adjacent plates shown in a closed position.

FIG. 5 is an enlarged, fragmentary cross-sectional view showing an edge of the membrane plate.

FIG. 6 is a front elevational view of a heating plate according to the present invention.

FIG. 7 is a front view of the heating plate similar to FIG. 6 but showing the plate with the heating element removed.

FIG. 8 is a front view of the heating element shown removed from the heating plate.

FIG. 9 is a fragmentary sectional view of the heating plate taken generally along line 9-9 in FIG. 6.

FIG. 10 is a fragmentary sectional view through the heating plate taken along line 10-10 in FIG. 6.

FIG. 11 is a front view of a heating plate corresponding to FIG. 6 but illustrating a modification thereof.

FIG. 12 is a front view of an alternate construction of the heating plate.

FIG. 13 is a central cross-sectional view of adjacent heating plates as shown in FIG. 12.

FIG. 14 is a front elevational view of still another variation of a heat plate for use in a filter press.

FIG. 15 is a partial cross-sectional view of the heat plate shown in FIG. 14.

FIG. 16 is an elevational view of solely the frame associated with the heat plate of FIG. 14.

FIG. 17 is a cross-sectional view of the frame shown in FIG. 16.

Certain terminology will be used in the following description for convenience in reference only, and will not be limiting. For example, the words “upwardly”, “downwardly”, “rightwardly” and “leftwardly” will refer to directions in the drawings to which reference is made. The word “forwardly” will be used in relationship to shifting of the plates in a closing direction, and the word “rearwardly” will refer to shifting of the plates in an opening direction. The words “inwardly” and “outwardly” will refer to directions toward and away from, respectively, the geometric center of the press and designated parts thereof. Said terminology will include the words specifically mentioned, derivatives thereof, and words of similar import.

### DETAILED DESCRIPTION

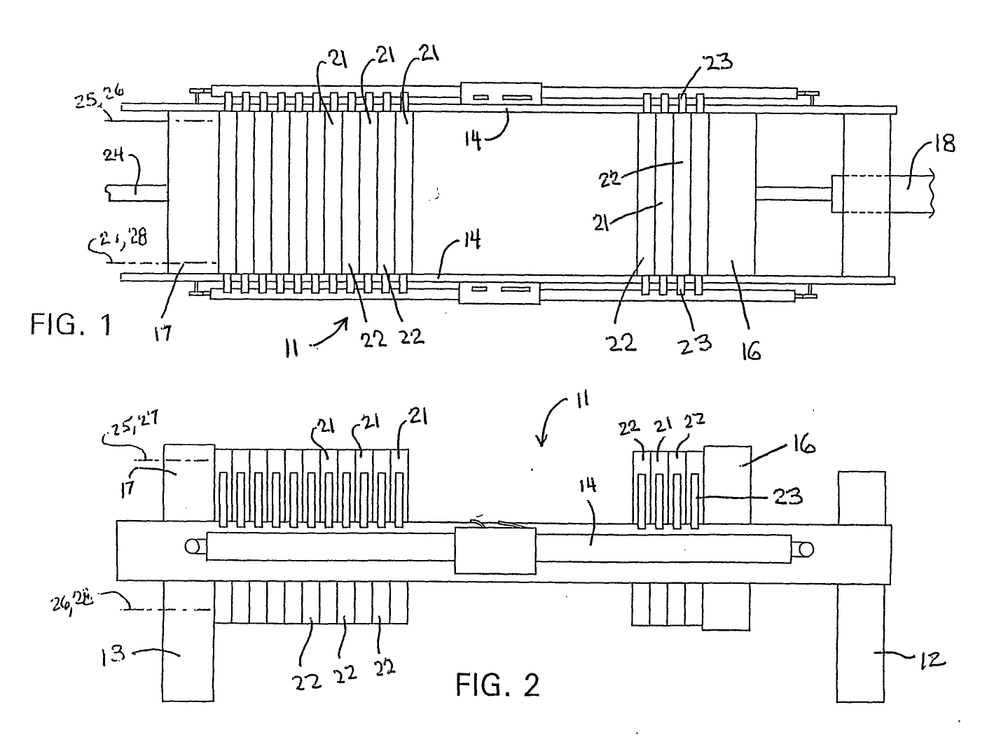

As shown in FIGS. 1 and 2, there is illustrated a filter press 11 having a pair of end supports 12 and 13 rigidly joined by a pair of generally parallel and horizontally elongate side rails 14, which side rails are sidewardly spaced apart and cooperate with the end supports 12 and 13 to define a generally rigid frame.

The filter press 11 has a movable follower or head arrangement 16 disposed adjacent one end of the press frame and slidably supported for movement along the side rails 14. The movable head 16 is slidably displaceable horizontally along the side rails toward and away from a further head 17 which is fixed to the frame adjacent the other end thereof. A drive device 18, such as a conventional double acting pressure cylinder, is mounted on the frame and cooperates with the movable head 16 for controlling movement thereof either toward or away from the fixed head 17.

A plurality of filter plates, namely alternating membrane filter plates 21 and heat filter plates 22, perform the filtering function of the press. The plates 21-22 are suspendedly supported on and between the side rails 14. The plates 21-22 extend generally transversely between the side rails 14 so that the plates are disposed in adjacent relationship to form a generally horizontally extending stack of plates in the longitudinal direction of the press 11. Each plate 21-22 has support arms or handles 23 which project outwardly from opposite sides of the respective plate in overlapping and slidable supportive engagement with the upper edges of the side rails 14, thereby enabling the plates to be slidably displaced along the side rails in the longitudinal direction of the filter press.

As is conventional the drive device 18 is activated to move the head 16 forwardly (leftwardly in FIGS. 1 and 2) so that the stack of plates 21-22 is snugly and tightly held between the opposed heads 16 and 17. In the illustrated embodiment a suitable conduit 24 is connected to the head 17 for communication with the interior of the stack of plates 21-22 for supplying slurry or sludge therethrough into the filtration chambers defined between the adjacent plates of the stack. A plurality of additional conduits 25, 26, 27, 28 also connect to the press, such as to the head 17, for communication with passages which extend through the stack of plates, typically along the corners of the plate stack for permitting communication with the filtration chambers for various operational functions during operation of the press. Such conduits 25-28 typically have their own individual control valves (not shown) associated therewith to permit the desired press function to be carried out.

To permit removal or dumping of solids (i.e. filter cake) which collects in the filtration chambers defined between adjacent plates, the head 16 is moved rightwardly in FIGS. 1 and 2 into an open position substantially as illustrated in FIG. 2, and the plates 21-22 are then individually and sequentially moved rearwardly (rightwardly in FIG. 2) away from the stack toward the movable head 16 to permit the solids which collect between adjacent plates to drop downwardly for deposit into a suitable collecting bin (not shown). The sequential and individual movement of the plates away from the stack is controlled by a conventional plate shifting mechanism.

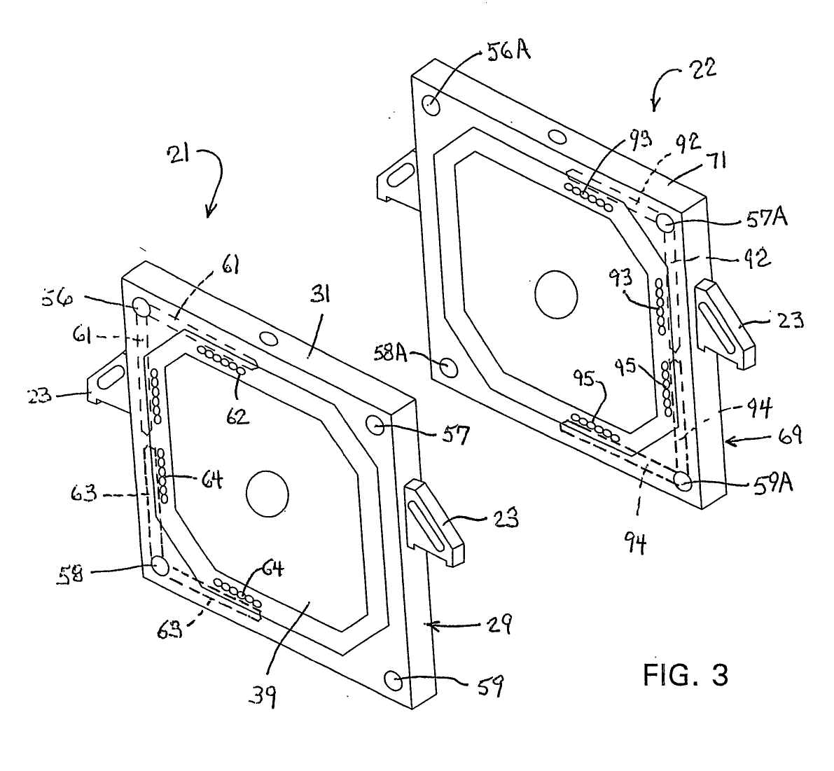

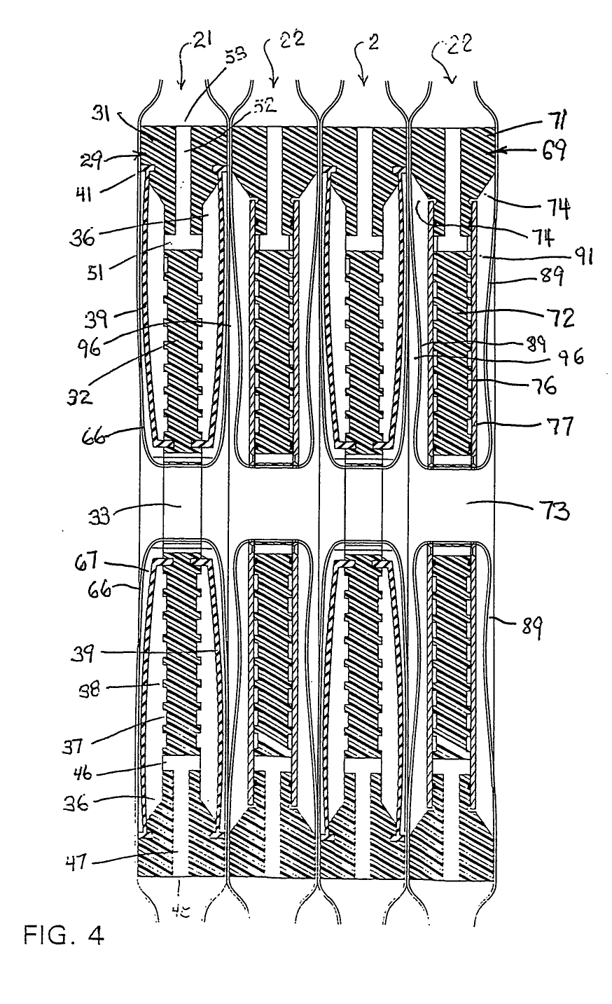

Considering the construction of the membrane-type filter plate 21, and referring to FIGS. 3 and 4, this plate includes a frame 29 with a ringlike peripheral edge portion 31 which is generally rectangular in shape and has generally flat and substantially parallel faces located at opposite sides thereof. The frame 29 includes a center partition or divider wall 32 which is rigidly joined to and defines the entire center of the peripheral edge portion, with this center portion 32 in the illustrated embodiment having a center opening 33 extending transversely therethrough. The edge frame 31 and divider wall 32 are preferably integral with one another, and typically comprise a molded plastic, such as polypropylene. The center wall 32 is reduced in thickness compared to the peripheral edge portion 31 so as to define transversely enlarged shallow recesses 36 on opposite sides thereof, which recesses 36 have a rear or bottom wall 37 defined by the center partition 32. This rear wall 37 is typically provided with a non-smooth surface such as ribs or a generally rectangular array of transversely spaced projections 38.

The membrane plate 21 also includes a flexible membrane or diaphragm 39 associated with and extending across each of the recesses 36. The membrane 39 is a thin flexible sheet of liquid impermeable elastomeric material, for example neoprene with nylon fabric reinforcement, and has a relatively small thickness so as to provide the membrane 39 with significant flexibility while at the same time providing significant heat transmission efficiency therethrough.

The diaphragm 39 is mounted on the frame 31 so as to extend across the respective shallow recess 36, and to do so the membrane has a surrounding peripheral edge part 41 which is retained in a groove 42 (FIG. 5) which is formed in the face of the frame in surrounding relationship to the respective recess 36. Suitable retaining strips or fasteners can be provided, in a conventional manner, to assist in securing the edge of the membrane within the frame groove.

With the membrane 39 mounted on the frame 29, a squeeze chamber 43 is defined between the diaphragm 39 and the rear wall 37 of the respective recess 36. To supply squeeze fluid (i.e., air or liquid) to the squeeze chamber 43, the frame 31 has a transverse passage 46 formed therein and in communication with the squeeze chambers 43 defined on opposite sides thereof, and this transverse passage 46 communicates with an inner end of a flow passage 47 which projects through the frame so as to terminate at a port 48 defined at the lower side edge of the frame. A similar transverse passage 51 is formed in the center divider wall of the frame adjacent the upper side thereof, and this passage communicates with one end of a flow passage 52 which projects through the frame and terminates at a port 53 defined in the upper peripheral surface of the frame. One of the ports, typically the lower port 48, couples to a suitable supply conduit which supplies a squeeze fluid, such as pressurized air or liquid, into the squeeze chambers 43 disposed on opposite sides of the plate, with the squeeze fluid being discharged from the squeeze chambers through the upper passage 52 which at the port 53 thereof connects to a suitable discharge conduit.

The frame 29 associated with each membrane plate 21 has, adjacent the four corners thereof, ports or passages 56, 57, 58 and 59 extending transversely throughout the thickness of the frame so as to terminate at the opposite side faces thereof. These ports align with corresponding ports formed in the other plates 21 and 22 when the plates are stacked together so as to define continuous flow passages which extend lengthwise throughout the plate stack. Appropriate seals can be provided in a conventional manner around the ports where they terminate at the side faces of the frame to create a seal between adjacent contacting plates if necessary.

At least an upper one and a lower one of the ports 56-59, and more typically upper and lower ports disposed adjacent the same side of the frame, are also disposed for communication with the filtration chambers defined adjacent opposite sides of the respective plate. For example, the upper port 56 communicates with a closed ended transverse passage 61 which extends transversely a limited extent along the edge frame and which in turn communicates with a plurality of small passages or ports 62 which extend transversely so as to open outwardly adjacent the front face of the respective membrane 39 to hence communicate with the respective filtration chamber. In the illustrated embodiment two such transverse passages 61 are formed for communication with the port 56 and project transversely away therefrom along the adjacent vertical and horizontal legs of the rectangular frame so as to terminate at ports 62 which open into the respective filtration chambers adjacent the upper corner thereof.

The lower port 58 which is disposed adjacent a lower corner of the frame on the same side as the port 56 similarly communicates with one or in the illustrated embodiment two transverse passages 63 which extend along the frame and, at their inner ends communicate with transverse passages or ports 64 which are defined just forwardly of the respective membrane 39 so as to provide communication with the lower corner of the respective filtration chamber.

The ports 57-59 as provided adjacent the other side of the frame 29 typically function solely as flow-through passages and do not have internal connecting passages within the respective frame.

Both sides of the membrane plate 21 are preferably covered by a suitable thin filter cloth 66 which readily permits liquids to flow therethrough, but which restricts passage of solids therethrough. Such cloth 66 may for example comprise a thin sheet of woven polypropylene. The filter cloth is mounted on the frame structure so as to extend across the shallow recess and is positioned so as to extend exteriorly over the outer face of the membrane. The membrane outer surface may be provided with a suitable texture or roughness if desired so as to permit the filter cloth from snugly adhering thereto. The liquids (i.e., filtrate) passing through the filter cloth enter into a liquid chamber 67 which is defined between the filter cloth and the front face of the membrane, which liquid chamber 67 at the outer edges thereof communicates with the ports 62 and 64. The filter cloth 66 may extend entirely across the faces of the plate so as to be secured exteriorly of the plate frame as diagrammatically illustrated in FIG. 4, or may be secured to the faces of the plate frame by suitable retainer rings, such being conventional and well known.

The construction and function of the membrane plate 21 is generally conventional, and further detailed description thereof is believed unnecessary.

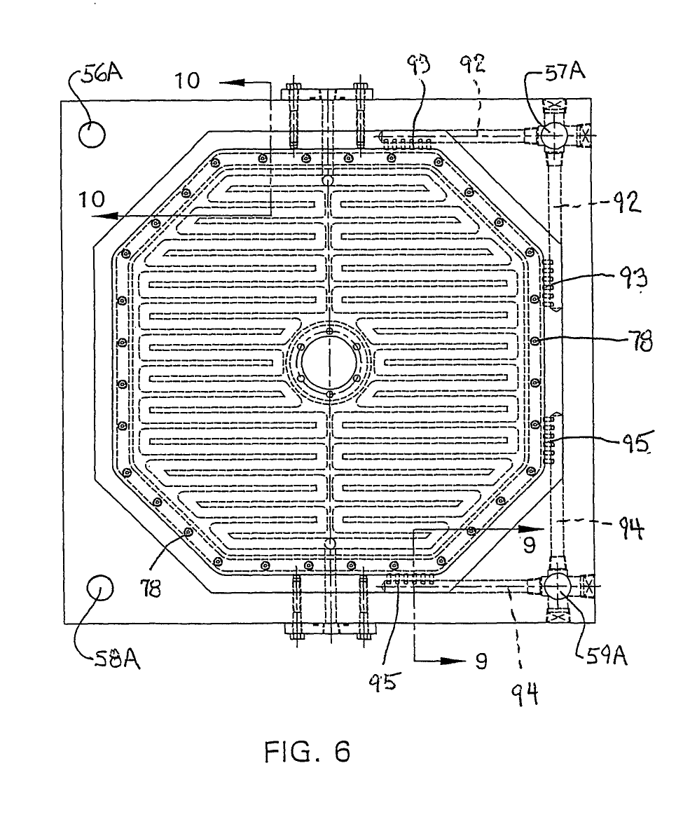

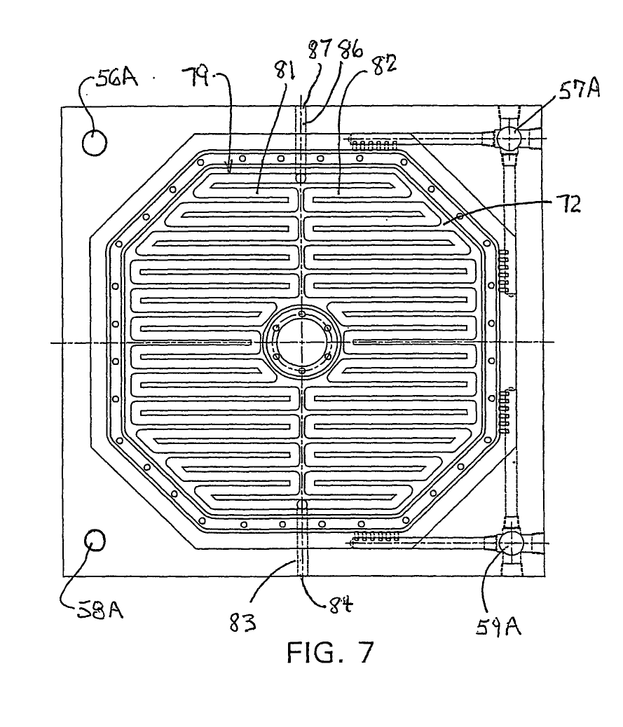

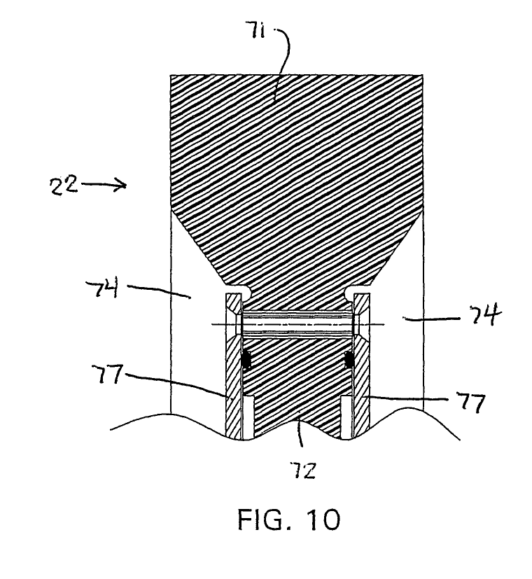

Considering now the construction of the heat plate 22, and referring specifically to FIGS. 3-4 and 5-10, this plate includes a frame structure 69 with an outer ringlike peripheral edge frame 71 which is generally rectangular and has generally flat and substantially parallel faces on opposite sides thereof. The frame structure 69 also includes a divider or center wall 72 which is rigidly joined to and extends across the center of the peripheral edge frame 71, but which in the illustrated embodiment is provided with a center opening 73 disposed for alignment with the center opening associated with the membrane plate. In the preferred construction the frame structure 69 is formed integrally in one piece, such as of a plastics material such as polypropylene. The center divider wall 72 has a reduced thickness relative to the thickness of the peripheral edge frame 71, resulting in the frame structure defining shallow recesses 74 opening outwardly from opposite sides thereof, which recesses 74 are transversely enlarged and have a bottom surface 76 defined by the divider wall 72.

The heat plate 22 also mounts a heat transfer member 77 which is associated with and overlies the bottom wall 76 of each side recess 74. This heat transfer member 77 is preferably formed from a material having a high heat conductivity, and in the illustrated embodiment is formed as a thin metal plate, such as a stainless steel plate, the latter extending substantially coextensively over the entire bottom wall of the recess and having the peripheral edge portion thereof sealingly seated on a surrounding shoulder associated with the frame structure and secured thereto by fasteners such as screws 78.

The heating plate 22 defines therein an interior flow passage arrangement 79 for permitting a heat transfer fluid, typically a liquid, to be supplied into and circulated therethrough so as to effect heating of the heat transfer plates 77, each of which effectively defines one of the side faces of the filtration chamber defined between adjacent plates 21-22. The flow passage arrangement 79 for the heat transfer fluid, in the embodiment illustrated by FIG. 7, includes a pair of passages 81 and 82 which are defined on the left and right sides of the plate and in effect each defines a generally sinusoidal passage which is formed inwardly from the bottom wall 76 of the recess 74 so as to hence be formed within the center divider wall 72. These passages 81 and 82 are, at the outer surfaces thereof, closed off by the thin heat transfer plate 77 so as to enable the heat transfer fluid passing through the passages to be brought into intimate contact with the rear surface of the heat transfer plate 77.

As illustrated by FIG. 7, the passages 81, 82 have the lower ends thereof in communication with a supply passage 83 which projects outwardly through the peripheral edge frame so as to terminate at a supply port 84, the latter being connected to a suitable conduit which supplies the heat transfer fluid into the interior of the heating plate. The other or upper ends of the passages 81 and 82 are connected in similar fashion to a further flow passage 86 which terminates in a discharge port 87 disposed at the outer peripheral edge frame, the latter connecting to a suitable discharge conduit for permitting the heating fluid to be removed from the interior of the plate. The fluid supplied to the plate through the supply port 84 hence is effectively divided into two separate flows as defined by the passages 81 and 82 so that fluid generally flows in parallel through these two passages so as to traverse vertically and horizontally throughout the interior of the plate until the flow paths again merge at the discharge passage 86.

The thin metal heat transfer plate 77 hence has the back or inside surface thereof positioned for intimate contact with the heat transfer fluid over a significant portion of the back surface area thereof so that heat is transferred to and then through the metal plate so as to thereafter be transmitted into the filter cake disposed adjacent the front surface of the plate. To prevent the filter cake from sticking directly to the heat transfer plate, however, a filter cloth 89 is generally provided so as to overlie each face of the heating plate, specifically so as to overlie the exterior face of the heat transfer plate 77, whereby the liquid passing through the filter cloth hence accesses a liquid chamber 91 as defined between the filter cloth and the front surface of the heat transfer plate 77.

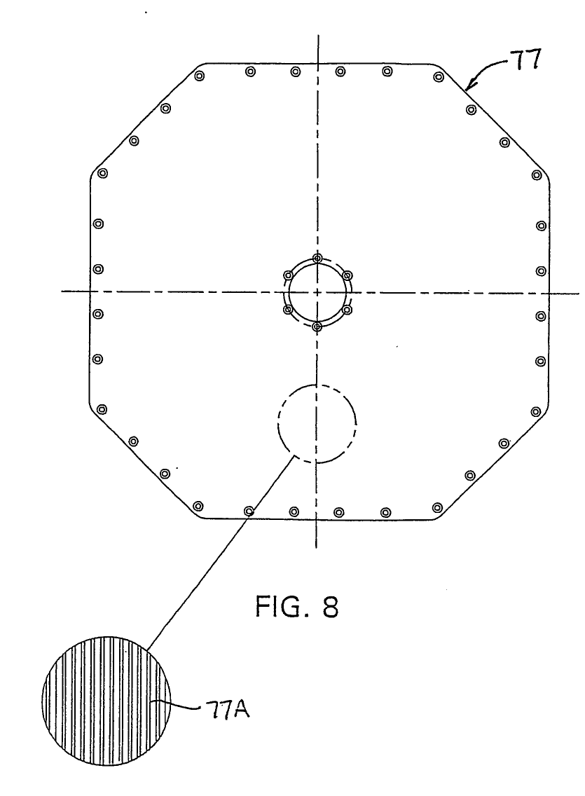

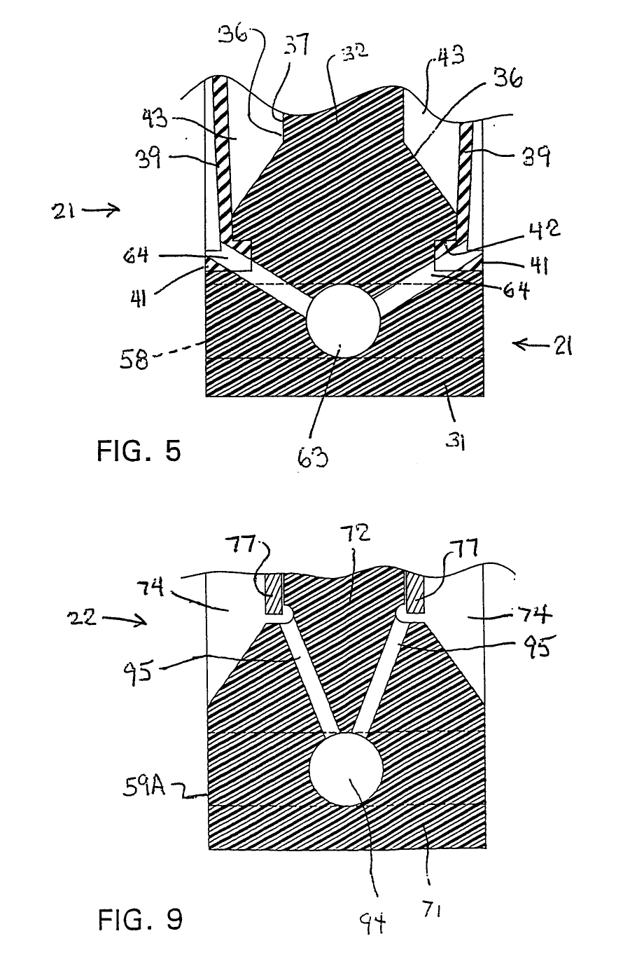

To further facilitate the downward flow and discharge of liquid from the liquid chamber 91, the front surface of the heat transfer plate 77 is preferably provided with an irregular or non-smooth surface which both prevents the filter cloth from snugly adhering thereto, and which also defines passages for flow of liquid thereacross. For example, in the illustrated arrangement the front surface of the heat transfer plate 77 is provided with a plurality of parallel and vertically extending shallow grooves 77A (FIG. 8) formed in the face thereof and extending vertically thereacross so as to define channels which facilitate the downward flow of liquid for discharge purposes. It will be appreciated that other structures and configurations can be provided on the front face of the heat transfer plate so as to accomplish these same objectives.

The frame structure 69 of heat plate 22 also has a plurality of ports 56A, 57A, 58A and 59A extending transversely therethrough between opposite side faces thereof in the vicinity of the four corners thereof. These ports 56A-59A are positioned so as to respectively align with the ports 56-59 associated with the membrane plate 21 when the plates 21-22 are disposed in alternating fashion on the press.

The ports 56A and 58A as disposed in the upper and lower corners on one side of the frame 69 function solely as through-flow ports, and do not provide any internal flow communication capability within the respective heat plate 22.

On the other hand, the upper port 57A associated with the other side of the heat plate 22 communicates with transverse passages 92 which, at their inner ends, communicate with ports 93 which open sidewardly through both sides of the heat plate frame for communication with the cavities or recesses 74 at a location forwardly of the front face of the metal heat transfer plates 77. The lower port 59A as disposed on the same side of the heat plate 22 similarly communicates with transverse passages 94 which at inner ends terminate with transverse ports 95 which also communicate with the cavities or recesses 74 at locations adjacent the front face of the respective heat transfer plate 77. The port 57A and its communication with the ports 93 hence provides a communication adjacent an upper corner of the filtration cavity, whereas the port 59A and its communication with the ports 95 hence provides communication with a lower corner of the filtration cavity.

The alternating arrangement of the membrane and heating plates 21 and 22, when in closed alternating positions as illustrated in FIGS. 1-2 and 4, thus defines a filtration chamber 96 between each adjacent pair of plates 21-22, which filtration chamber 96 has one side thereof effectively defined by the membrane 39 and the other side thereof defined by the heat plate 77, with the solids being confined generally between the filter cloth 66 and 89. The respective upper and lower ports 62 and 64 associated with the membrane plate communicate with upper and lower corners of the filtration chamber adjacent one face thereof (i.e., adjacent the membrane plate side thereof), and also adjacent one side edge thereof; whereas the ports 93 and 95 associated with the heating plate 22 communicate with the opposite face of the filtration chamber adjacent upper and lower corners thereof as disposed adjacent the opposite side edge of the chamber.

The operation of the press illustrated by FIGS. 1-9 will now be briefly described.

The membrane and heating plates 21 and 22 are initially alternately positioned on the press frame so that the ports 56, 57, 58 and 59 associated with the membrane plates 21 are all aligned with one another, and are also aligned with the respective ports 56A, 57A, 58A and 59A associated with the alternating heating plates 22.

With the press in a closed position, the solid-liquid slurry is pumped into the press through the supply conduit 24 so that the slurry flows through the aligned center openings 33 and 73 so as to fill the filtration chambers 96 defined between adjacent pairs of plates 21-22. During filling of the press, the pressure of the slurry supplied to the press effects solid-liquid separation in that a significant quantity of liquid will typically flow through the filter cloth and thence through the ports 64 and 95 as respectively defined in the membrane and heating plates and as associated with the bottom regions of the filtration chambers, which liquid then flows into the lower ports 58-58A and 59-59A, which ports define drain passages permitting the liquid to flow into and be discharged through the conduits 26 and 28 coupled thereto. When the pressurization of the filter press results in maximum discharge of liquid in the manner described above, there remains a relatively high concentration of moist solids which define a filter cake between the filter cloths of each filtration chamber 96. Thereafter subsequent treating operations can be carried out thereon.

For example, a pressurized squeeze fluid is supplied into the squeeze chambers so as to deflect the membranes 39 outwardly to effect compression of the filter cake to assist in squeezing further liquid therefrom.

Simultaneous with or subsequent to the squeezing of the filter cake, an air blow operation can be undertaken so as to effect removal of moisture from the filter cakes. During air blow, valves associated with diagonally-opposite conduits 25 and 28 are opened so that pressurized air can be supplied through conduit 25 into the passage defined by ports 56-56A. The air in this passage is then supplied solely through the upper transverse passages 61 and ports 62 associated with the membrane plates 21 into the upper corners of the filtration chambers. The air then flows diagonally downwardly through the filter cake thickness, and also flows longitudinally across the filter cake, so as to access the ports 95 which are located on the diametrically opposite corner of the filtrate chamber and on the opposite face of the filter cake, which ports 95 communicate through the transverse passage 94 with the passage defined by ports 59-59A, the latter being open to a discharge point. The air flowing through the cake, both across the width and through the thickness thereof, is effective for removing additional moisture.

If desired, a second air blow cycle can be carried out in the opposite diagonal direction by closing the valves associated with conduits 25 and 28, and opening the valves associated with conduits 26 and 27, whereby pressurized air is then supplied to the passage defined by ports 57-57A and thence through the upper ports 93 of the heating plates, with the air flowing diagonally across and longitudinally through the filter cake so as to access the open ports 64 on the diagonally opposite lower corner of the membrane plates, for discharge through the passage defined by aligned ports 58-58A.

Thereafter hot heating fluid can be supplied into and through the interior of the heat plates 22 to effect heating of the thin metal heat plates 77, which due to their intimate contact with the filter cake is effective for heating the filter cake to a higher temperature. At the same time a hot squeeze liquid can be supplied behind the membranes 39 to not only effect expansion thereof, but to also permit at least limited heat transfer through the membranes to the adjacent filter cake to assist in heating the cake. Thereafter preferably the valves associated with all of the aligned ports 56-56A, 57-57A, 58-58A and 59-59A can be opened and these ports connected to a vacuum source. The vacuum applied to these ports is applied to the filter cakes contained within the filtration chambers which, in conjunction with the heating of the filter cakes as described above, results in lowering of the vaporization temperature of the liquid within the filter cakes so as to cause some vaporization of the liquid, which vapor is then sucked out of the filter cakes into the passages 56-56A through 59-59A for external discharge.

With the above process and in conjunction with the desirable arrangement of the heating and membrane plates, maximum drainage from the filtrate chambers can be achieved since both the heating and membrane plates employ drainage ports in communication with the filtrate chamber, and at the same time the disposition and control of these ports in terms of their opening and closing greatly facilitates efficient air blow and hence moisture removal from the filter cake by permitting controlled air blow through the cake in a manner which causes the air to not only blow diagonally across the width of the cake but also requires that the air during its passage through the cake travel longitudinally through the cake thickness. This overall arrangement hence facilitates a more efficient and effective removal of moisture from the cake, thereby permitting for improved drying thereof within the press.

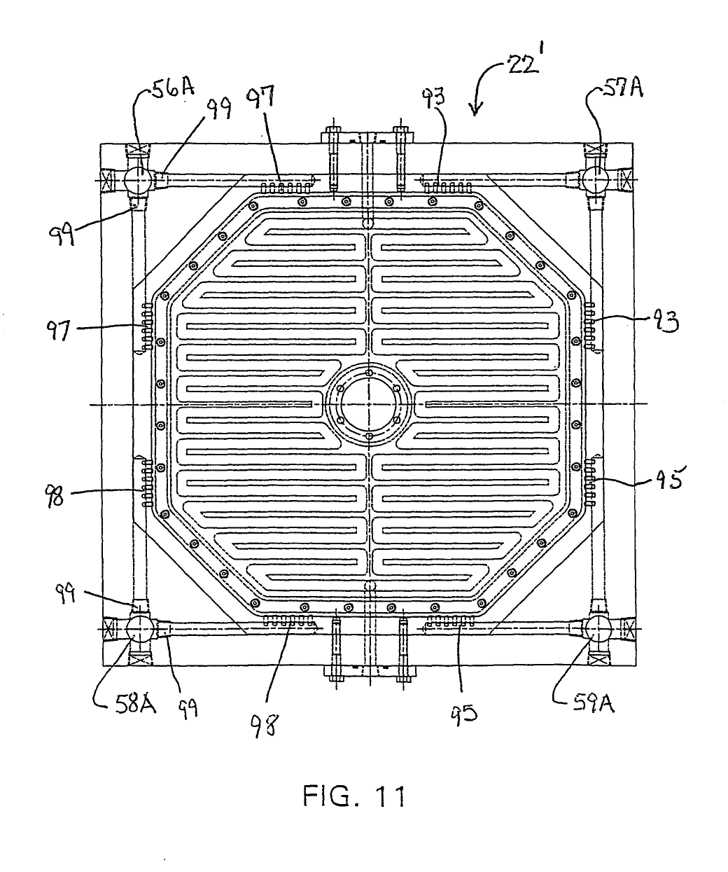

Referring now to FIG. 11, there is illustrated a variation of a heat plate 22′ according to the present invention. The heat plate 22′ is identical to the heat plate 22 described above except that, in this variation, each of the corner ports 56A, 57A, 58A and 59A has appropriate transverse passages and communication ports associated therewith. That is, while the ports 57A and 59A communicate with the plate cavity through respective ports 93 and 95 as described above, the remaining ports 56A and 58A can likewise be allowed to communicate with the cavities through additional ports 97 and 98. With this arrangement, there thus is no need to define right or left sides during initial installation of the heating plate on the press since the plate possesses symmetry irrespective of its directional orientation. Once installed, however, selected ones of the ports 56A-59A can be effectively isolated from the plate cavities merely by installing an appropriate closure plug, such as the plugs 99 illustrated in FIG. 11, which plugs are illustrated as effecting isolation of the ports 97 and 98 from the respective ports 56A and 58A.

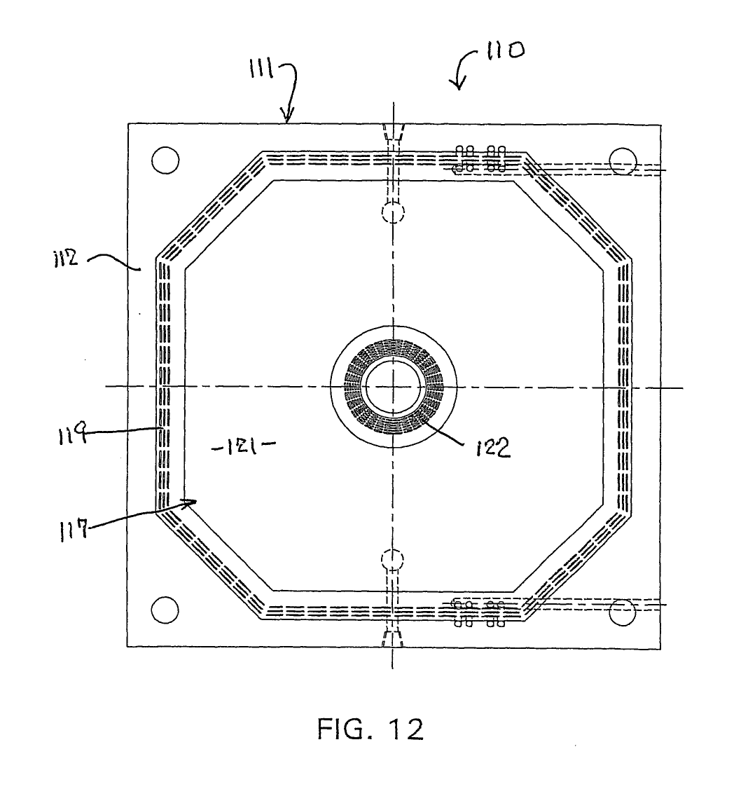

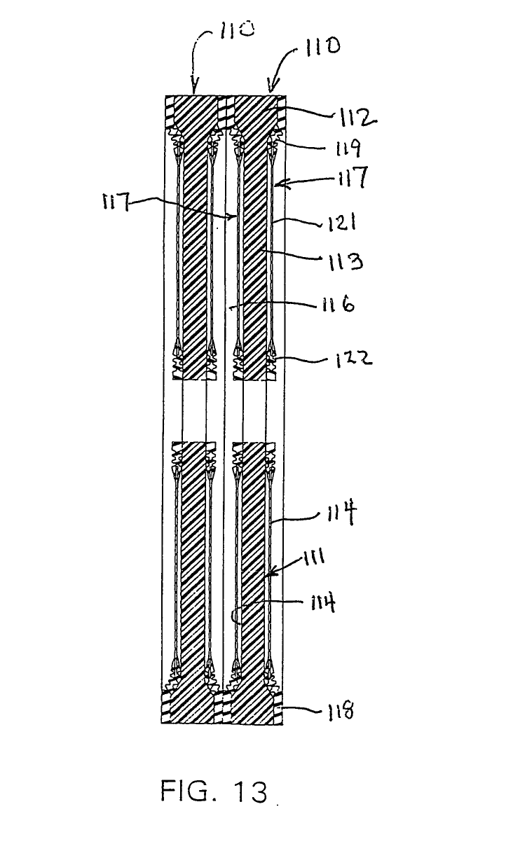

Referring now to FIGS. 12 and 13, there is illustrated a variation of a filter plate 110 for use in a filter press, which filter plate is a hybrid plate in that it functions both as a membrane plate and as a heating plate.

The plate 110 includes a main frame 111 typically of plastics material such as polypropylene and having a rectangular outer edge frame 112 integrally joined to a reduced width center wall 113, the latter in this embodiment again having a central opening extending transversely therethrough. This center wall 113 defines recesses 114 on opposite sides thereof which function to define a filtration cavity 116 between two adjacent closed plates, as illustrated by FIG. 13. Each plate 114 has a heat-transfer membrane 117 associated therewith for extension over the respective cavity 114. The membrane 117 in this arrangement includes an outer rim part 118 which is fixed to the plate frame 111 and, in the vicinity of the outer edge of the recess 114, is provided with a flexing annulus or bellows 119 which at a radially outer edge is integrally joined to the rim part 118 and, at its radially inner edge is fixedly secured, as by bonding or mechanical fasteners, to the outer peripheral edge of a thin metal heat plate 121. This metal heat plate 121, in the embodiment possessing a center opening, has its inner edge around the center opening secured to a further flexing annulus or bellows 122 which has its radially inner edge secured to the center dividing wall of the plate frame. The edge part 118 and its integrally joined bellows 119, as well as the inner bellows 122, are preferably formed from a plastics material, such as by being molded of a thin material such as polypropylene, and the bellows 119 and 122 are provided with a suitable configuration, i.e., a corrugated configuration such as a series of interconnected rings, so that the inner and outer bellows 119 and 122 permit the heating plate 121 to move transversely away from the center wall 113 when a squeeze liquid is supplied behind the membrane. With this arrangement, the squeeze liquid applied behind the membrane is effective for displacing the membrane to effect squeezing of the filtrate in the filtration chamber, and at the same time the heating plate 121 (having properties similar to that described above relative to the heat plate 77) is effective for permitting high efficiency transfer of heat from the squeeze liquid to the filter cake so as to facilitate removal of volatiles therefrom.

The modified plate 110 of FIGS. 12-13 thus carries out both the membrane squeeze function as well as the heat transfer function, and hence the press can be equipped throughout with a plurality of identical plates. Alternatively, the plate 110 may be used in conjunction with conventional cloth-type chamber plates as discussed above in the background section, or with heat plates 22, 22′ illustrated in FIGS. 1-11.

With the plates of FIGS. 12 and 13, the alternating plates are preferably positioned such that the ports which communicate with the filtration chamber are alternately positioned on opposite sides of the plate stack so as to permit air blow to be carried out in the same manner as described above relative to FIGS. 1-10. Further, the heat transfer membrane 117 can incorporate therein drainage or dewatering grooves similar to grooves 77A.

With the improved filter press of the present invention, it will be appreciated that utilization of separate heating plates of the type illustrated by FIGS. 1-10 enables a significantly higher-temperature heat-transfer fluid to be supplied to the heating plates for transfer of heat to the filter cake. Since the material of the membranes associated with the membrane plates is such as to limit the temperature of the squeeze fluid supplied to the chambers behind the membranes, the providing of separate heat transfer plates, and the fact that they can accommodate significantly higher temperatures, greatly improves the ability to provide effective heat transfer to and heating of the filter cake so as to permit removal of vapors therefrom.

The construction of the heat plate 22 is also desirable since the thin metal heat transfer members are confined interiorly within the plate frame when the press is closed, and the surrounding frame of plastics material functions generally as a thermal insulator so as to avoid creating a high temperature exterior surface which can be potentially dangerous to operating personnel. In addition, since plastic is not a good heat transfer material, it is not effective in absorbing significant quantities of heat from the heat transfer liquid, and hence the heat energy from the heat transfer liquid is more readily available for transfer through the metal heat transfer plates to the filter cake. A higher heat transfer efficiency can thus be achieved.

While it is believed that utilization of heating plates employing a heat transfer fluid will normally be preferred in most environments employing filter presses of this type, it will be appreciated that other means for heating the heat transfer plates can be utilized within the scope of the present invention. For example, the heat transfer plates 77 could be provided with electric heaters associated therewith if desired, which heaters can be activated only during that portion of the filtration cycle when heating of the filter cake is desired.

When the press is of the center fill type as disclosed herein, it will be appreciated that air blow through all four corners of the filtration chambers may be feasible, and in such instance the air blow from the four corners will result in the flow being directed inwardly toward the center of the plates, with the air blow being discharged along the center opening into the main center conduit.

While a center feed has been associated with the press illustrated and described herein, it will be recognized that a center feed is only one conventional technique for feeding a filter press, and that filter plates employing feeds other than a center feed can be provided. The arrangement of the present invention is equally applicable to those filter presses which do not employ a center feed.

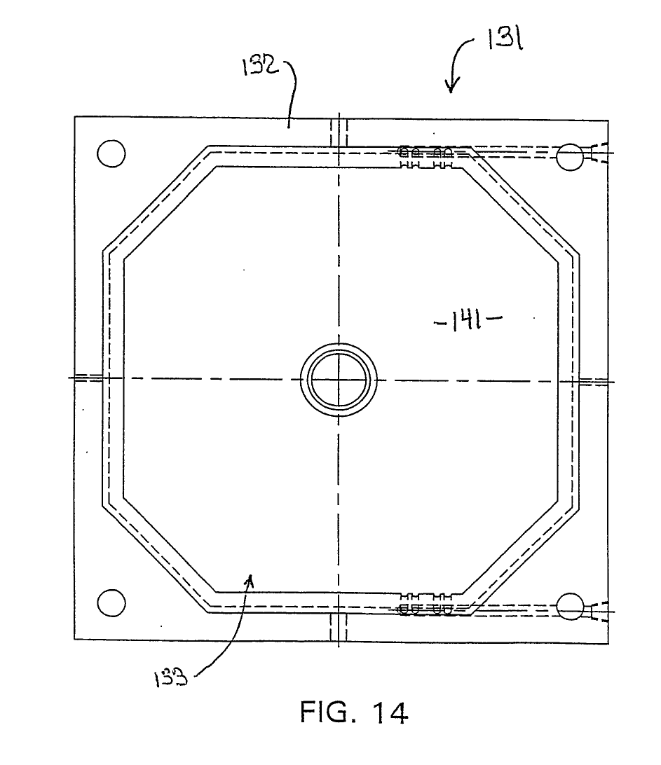

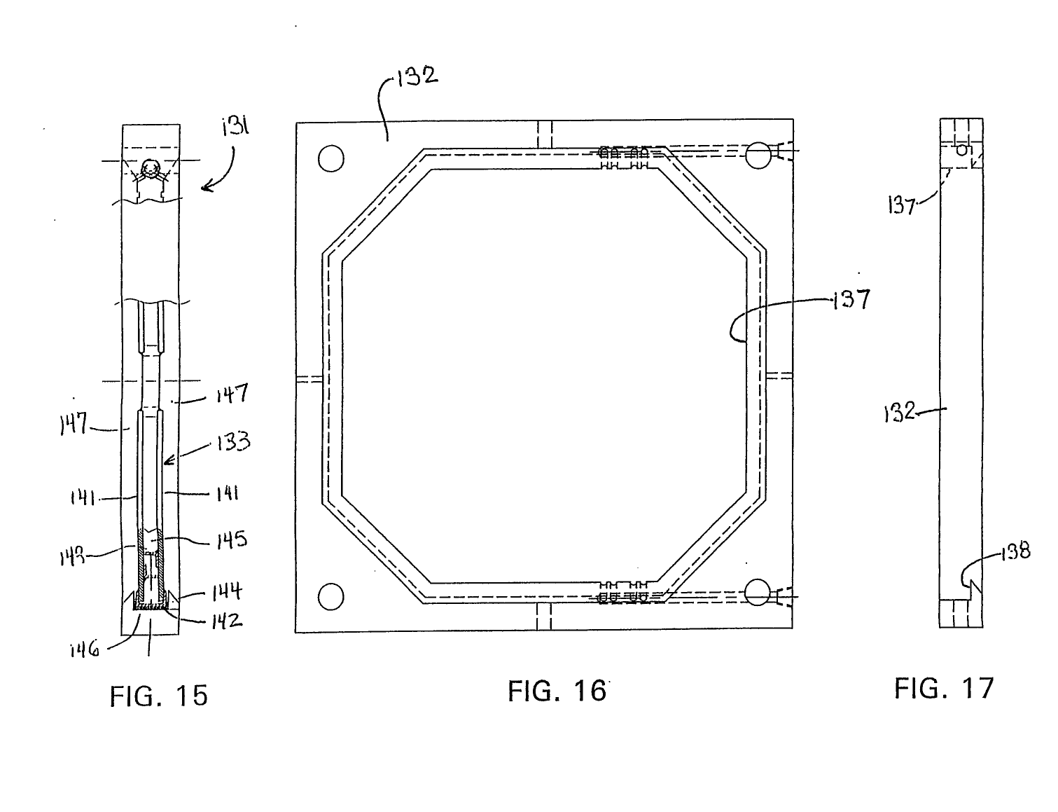

Referring now to FIGS. 14-17, there is illustrated a still further version of a heat plate for use in a press according to the present invention. The heat plate 131 illustrated by these figures includes a generally rectangular ringlike frame 132 constructed of a plastics material, such as polypropylene, and this frame 132 mounts therein a heat transfer assembly 133 which defines therein an interior chamber for circulation of heat transfer fluid.

The frame 132 is similar to the previously described heat plate frame in that the corners are again provided with ports and transverse passages associated therewith, and hence these will not be further described. The frame 132, however, is not provided with a center divider wall, but rather is provided with a large opening or recess 137 which extends entirely through the frame, which recess accommodates therein the heat transfer assembly 133. The recess 137, adjacent one side of the outer edge thereof as illustrated in FIG. 17, is bordered by a shoulder 138.

The heat transfer assembly 133 is sized and shaped so as to fit within the recess 137 and, as illustrated by FIG. 15, the heat transfer assembly 133 includes a pair of generally parallel but thin metal heat transfer plates 141 which are sidewardly spaced apart and which around the peripheral edges are rigidly joined, such as by a channel member 142, so as to effectively define a closed hollow box. The interior of this heat transfer assembly defines a cavity or passage 145 therein for accommodating heat transfer fluid, and in the illustrated embodiment a plurality of flow diverting elements 143 are joined to and extend transversely between the heat plates 141 so as to define an appropriate flow path for the fluid, such as the flow path described above.

The heat transfer assembly 133 fits within the recess 137 so as to abut against the shoulder 138, and an appropriate heat insulating strip 146 can be positioned between the frame and the heat transfer assembly. A retaining strip 144 is then secured to the frame adjacent the other side of the heat transfer assembly so as to rigidly retain the heat transfer assembly to the frame.

As illustrated by FIG. 15, the heat transfer assembly as defined by the transverse width across the pair of spaced heat transfer plates 141 is significantly less than the width of the frame 132, whereby the assembled heat plate 131 hence effectively defines enlarged shallow recesses 147 on opposite sides thereof which effectively define one side of the filtration chamber when the heat plate is assembled into the press.

The frame 132 is again provided with appropriate heat transfer fluid passages extending therethrough, such as through the upper and lower rims thereof, for communication with the heat transfer chamber 145 defined by the heat transfer assembly 133.

The construction illustrated by FIGS. 14-17 results in the entire heat transfer assembly 133 being constructed of metal so as to both withstand the high temperatures of the heat transfer fluid, and at the same time permit efficient transfer of heat energy to the filter cakes disposed in the filtration chambers on opposite sides of the heat plates. The metal heat transfer assembly 133, however, is still supported by and surrounded by the plastics material defining the support frame 132, and hence the latter prevents undesired heat loss from the heat transfer assembly and minimizes the temperature to which the exterior or exposed surfaces of the filter plates 131 are subjected.

The heat transfer plate 131 can obviously be provided with other structural and functional features as described above, and will be used in alternating fashion between membrane plates 21 as also described above.

It will be appreciated that numerous conventional variations can be incorporated into the press and filter plates according to the present invention. For example, while the membranes have been illustrated for simplicity purposes as having smooth exterior surfaces, it will be recognized that these exterior surfaces are preferably provided with projections or nibs to provide flow passages for the filtrate, such being conventional in membrane construction. Also, the heat transfer chamber defined behind the heat transfer plate may assume any desired shape or configuration so as to provide for intimate and optimum contact between the heat transfer fluid and the heat transfer plate. Further, while the illustrated embodiment discloses the heat transfer fluid being supplied and discharged vertically relative to the heat plate, it will be appreciated that the supply and discharge ports for the heat transfer fluid may be oriented in whatever location or position is most convenient with respect to the press and the auxiliary equipment. Still further, while the press as illustrated employs side bars for supporting the filter plates, other conventional filter press arrangements can be provided, including for example a conventional overhead support bar for the filter plates.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A filter press comprising:
a frame including an elongate rail structure;
first and second head assemblies supported on said rail structure adjacent respective opposite ends thereof, said head assemblies being relatively movable to permit opening and closing of said press;
a plate arrangement including a plurality of individual plates supported on said rail structure between said first and second head assemblies, said plurality of plates being disposed in a generally horizontally extending closed stack and clampingly held between said first and second head assemblies when said press is in a closed position;
said plurality of plates comprising a plurality of first plates each including a frame having a pair of oppositely disposed faces, a peripheral portion, and a central portion which is recessed inwardly with respect to said peripheral portion, a pair of liquid impermeable and flexible membranes fixed to said frame and extending across the respective opposite faces thereof to define respective pressure chambers between said central portion and the respective membranes; and
said plurality of plates comprising a plurality of second plates each including a frame having a pair of oppositely disposed faces, a peripheral portion, and a central portion, a pair of heat transfer members disposed within said central portion, said heat transfer members being disposed sidewardly inwardly relative to said peripheral portion of said second plate, said central portion of said second plate defining therein a chamber which communicates with a supply of heated fluid and is disposed to bring the heated fluid within said chamber into contact with respective inner surfaces of said heat transfer members;
said first and second plates being disposed in an alternating manner along said rail structure in adjacent sealing contact with one another in said closed position of said press to define respective filter chambers therebetween for filtering and collecting solids from a slurry entering the respective filter chambers, each said filter chamber being defined on one side by a said membrane of a said first plate and on the opposite side by a said heat transfer member of a said second plate, and said pressure chambers communicating with a fluid source to expand said membranes of said first plates towards the respective adjacent second plates.

2. The filter press of claim 1 wherein said second plates define therein a drainage passage which communicates with the respective filter chamber to permit drainage of the liquid portion of the slurry through said second plates.

3. The filter press of claim 2 wherein said first plates define therein a drainage passage which communicates with the respective filter chamber to permit drainage of the liquid portion of the slurry through said first plates.

4. The filter press of claim 1 wherein each said first plate mounts thereon a pair of liquid permeable filter members which overlie the respective membranes, each said filter member and the respective adjacent membrane together defining a drainage chamber therebetween, and each said second plate mounts thereon a pair of liquid permeable filter members which overlie the respective heat transfer members, each said filter member of said second plates and the respective adjacent heat transfer member together defining a drainage chamber therebetween, each said first and second plate defining a passage therein in communication with the respective drainage chambers to permit drainage of the liquid portion of the slurry from opposite sides of the respective filter chambers.

5. The filter press of claim 4 wherein each said heat transfer member defines therein a plurality of grooves which open toward the respective adjacent filter member to define a drainage surface across said heat transfer member.

6. The filter press of claim 1 wherein said central portion of each said second plate defines thereon a pair of oppositely facing side surfaces, and said heat transfer members being respectively fixed to and overlying said oppositely facing side surfaces of said central portion of said second plate.

7. The filter press of claim 1 wherein said central portion of each said second plate is hollow, and each said second plate comprises a heat transfer assembly disposed within said central portion and including said heat transfer members, said heat transfer members being sidewardly spaced from one another to define therebetween said chamber for receiving heated fluid therein to heat said heat transfer members.

8. The filter press of claim 1 wherein said heat transfer elements are constructed of metal, and said frame of each said second plate is constructed substantially of a non-metal material, such as plastic.

9. The filter press of claim 1 wherein each said first plate mounts thereon a pair of liquid permeable filter members which overlie the respective membranes, each said filter member and the respective adjacent membrane together defining a drainage chamber therebetween, and each said second plate mounts thereon a pair of liquid permeable filter members which overlie the respective heat transfer members, each said filter member of said second plates and the respective adjacent heat transfer member together defining a drainage chamber therebetween, each said first and second plate defining porting therein including upper and lower ports, said upper and lower ports of said first plates being disposed diametrically opposite the respective lower and upper ports of the adjacent said second plate, said porting of said first and second plates communicating with the respective drainage chambers to permit drainage of the liquid portion of the slurry from the respective filter chambers.

10. The filter press of claim 9 wherein said porting of said first and second plates additionally permits air blow through a filter cake disposed in a said filter chamber such that the air passes both transversely across the width of the filter cake and longitudinally through the filter cake.

11. A filter press for separating liquid from a slurry, said press comprising:
a horizontally extending stack of plates disposed in side-by-side relation and supported on an elongate support frame which permits opening and closing of said stack, said plates being clampingly held together in sealed relationship with one another by said support frame to define a closed position of said press;
said stack of plates comprising first plates each including a rigid frame having a pair of oppositely disposed faces and being recessed inwardly on opposite sides thereof, said frame mounting thereon a pair of liquid permeable filter members which extend across the respective recesses of said frame to define respective drainage chambers, said stack further comprising second plates disposed in an alternating fashion with said first plates, each said second plate including a rigid frame having a pair of oppositely disposed faces and including thereon a pair of heat transmitting surfaces on respective opposite sides thereof, said heat transmitting surfaces being recessed inwardly relative to a peripheral portion of the respective second plate, the adjacent first and second plates together defining a filter chamber therebetween, and each said first and second plate defining ports therein in communication with the respective drainage and filter chambers to permit drainage of liquid from the slurry through both said first and second plates.

12. The press of claim 11 wherein said frame of each said second plate includes a central wall having opposite sides on which the respective heat transmitting surfaces are defined, said central wall defining therein heating passages disposed to conduct heated fluid along the respective heat transmitting surfaces to heat same and a filter cake formed in the respective filter chamber.

13. The press of claim 11 wherein said frame of each said first plate includes a central portion surrounded by a peripheral portion, said central portion being recessed inwardly relative to said peripheral portion, each said first plate mounting thereon a pair of liquid impermeable membranes each disposed between said central portion and a respective said filter member, each said membrane and said central portion together defining a pressure chamber therebetween for receiving pressurized fluid to expand said membrane towards the respective second plate.

14. The press of claim 11 wherein each said second plate mounts thereon a pair of liquid permeable filter members which overlie the respective heat transmitting surfaces, each said second plate defining a drainage chamber between each said filter member and the adjacent heat transmitting surface, and each said heat transmitting surface defining therein drainage grooves which open towards the respective filter member.

15. A plate for a filter press for separating liquid from a slurry, said plate comprising:
a rigid frame including a peripheral portion disposed in surrounding relation with a central portion, said central portion having a width which is less than said peripheral portion such that inwardly projecting recesses are respectively defined on opposite sides of said frame; and
a pair of heat transfer elements disposed on opposite sides of said frame and within the respective recesses, each said heat transfer element comprising an outer peripheral portion fixed to said frame and defining a flexible bellows, and a metal heat plate fixed to an inner edge of said bellows and extending across the respective recess of said frame, each side of said central portion and the adjacent said heat transfer element together defining a chamber which communicates with a supply of heated fluid to provide intimate contact between the heated fluid and an inner surface of the respective heat plate.

16. The filter plate of claim 15 wherein said frame defines therein a flow passage arrangement which communicates with respective filtrate chambers defined at respective outwardly facing side surfaces of said heat transfer elements, said flow passage arrangement additionally communicating with a liquid discharge conduit to permit drainage of liquid from the slurry through said plate.

17. A plate for a filter press for separating liquid from a slurry, said plate comprising:
a frame including an outer peripheral portion disposed in surrounding relation with a central portion, said frame being constructed of a material having a low heat conductivity, said central portion having oppositely facing sides which are recessed sidewardly inwardly relative to said peripheral portion; and
a pair of heat plates fixed to the respective sides of said central portion so as to overlie same, said heat plates being disposed sidewardly inwardly relative to said peripheral portion so as to define part of a filtration chamber when disposed adjacent another filter press plate, said sides of said central portion of said frame defining therein flow passages which receive heated fluid and transport the heated fluid into intimate contact with the respective said heat plates to heat same.

18. The plate of claim 17 wherein said plate defines therein a port arrangement which communicates with the respective filtration chambers to permit drainage of liquid portion of the slurry through said plate and to permit air blow of cakes formed in the respective filtration chambers to dry same.

19. The plate of claim 18 wherein each said heat plate defines thereon an irregular surface to prevent sticking of the filter cake thereto and to provide a drainage area for liquid portion of the slurry.

20. The plate of claim 19 wherein said irregular surface comprises a plurality of grooves which open sidewardly towards the respective filtration chamber.
